(19) United States
(12) Patent Application Publication
(10) Pub. No.: US 2011/0214154 A1
(43) Pub. Date: Sep. 1, 2011

(54) VIEWING CONTROL APPARATUS AND SYSTEM

(76) Inventor: SATOSHI NAGANO, Kunitachi (JP)

(21) Appl. No.: 12/974,657

(22) Filed: Dec. 21, 2010

(30) Foreign Application Priority Data
Mar. 1, 2010 (JP) 2010-043674

(51) Int. Cl. H04N 7/173

(52) U.S. Cl. 725/87

(57) ABSTRACT

A viewing control apparatus for viewing a broadcast program, includes a processor which controls channel switching of the broadcast program and reproduction of VOD (Video on Demand) contents. The processor generates a virtual channel in combination of the broadcast program and automatically-recommended VOD contents, controls channel switching of the broadcast program and reproduction of the VOD contents based on a program list of the generated virtual channel, and switches an image displayed on a display unit.

### INCORPORATION BY REFERENCE

The present application claims priority from Japanese application JP2010-043674 filed on Mar. 1, 2010 the content of which is hereby incorporated by reference into this application.

### BACKGROUND OF THE INVENTION

The present invention relates to viewing control apparatuses and viewing control systems, and more particularly, to a technique which allows users to passively view VOD (Video On Demand) contents.

Multi-channelizing of a TV set due to appearances of a Broadcasting Satellite, Communication Satellite, and Community Antenna Television (CATV) expands a range of program selections for viewers. At the same time, when viewing a real-time broadcast program organized by a broadcasting station, a viewer cannot necessarily view a program suitable for the viewer's preference. The viewer is forced to switch channels and desires efficient program selections and improvement in a program search system. It is considered that due to appearances of IPTV (Internet Protocol Television), a range of program selections of viewers is further broadened and also, a viewing mode such as not only a real-time viewing as in a conventional broadcasting but also VOD and download becomes diversified. Accordingly, demand of efficient program selections and program search system of viewers is considered to become ever-increasing. A content recommendation method is one of the above-described efficient program selection methods, and a number of inventions have been heretofore performed.

In the IPTV and CATV services, a VOD service which allows users to view a favorite program at any time is provided in addition to a multi-channel broadcasting service. However, a utilization rate of the multi-channel broadcasting service is sufficiently higher than that of the VOD service in a television image service market. Further, a utilization of the VOD service is still definite, regardless of rich contents. Specifically, the above-described fact shows the following. That is, as a viewing mode of a TV set, a trend of a mode for selectively viewing a program from those broadcasted in real time, so-called, that of a passive viewing mode is high at present. Further, a trend of an active viewing mode for viewing contents like the VOD in a positive manner is low.

As a conventional technique for improving the above-described conditions, in JP-A-2009-206957 and U.S. application publication No. 2009/0222857, there is disclosed a technique in which when VOD contents with attributes different from those of a real-time on-air program are recommended, a viewer can expand a range of selectable programs at that time, and as a result, an improvement in the convenience of viewers is realized.

In JP-A-2007-306395, there is disclosed a technique in which when recommendation programs are presented from currently on-air programs along the time axis within a program list to assist a viewer in viewing a program suitable for a viewer's preference from the currently on-air program is supported.

In JP-A-2009-44435 and U.S. application publication No. 2009/0044223, there is disclosed a technique in which for the purpose of expanding a range of program selections based on the will of viewers, when a VOD program which is previously reserved for viewing is displayed as a VOD playlist in an electronic program guide based on the uniform management with broadcast programs to thereby improve the convenience of the VOD viewing.

In JP-A-2002-44632 and U.S. application publication No. 2002/0059649, there is disclosed a technique in which a method for displaying contents recorded in a hard disk along the time axis and building a virtual channel is presented.

### SUMMARY OF THE INVENTION

In the case of JP-A-2009-206957, the VOD contents are recommended for viewers, however, the viewers need select the VOD contents from among a recommended program list and actively view the VOD contents.

In the case of JP-A-2007-306395, the viewing of a program suitable for a viewer's preference from a currently on-air program is supported. A range of program selections covers the currently on-air programs, and the above-described case is restricted more than that of using the VOD in the range of program selections of viewers. Further, no reference is made to the VOD.

In the case of JP-A-2009-44435, the VOD contents are displayed as a VOD playlist in an electronic program guide; however, a viewer need previously register a reservation for the viewing of the VOD contents, and actively view the VOD contents after all.

In the case of JP-A-2002-44632, since a recorded content is displayed along the time axis to build a virtual channel, an on-air program or VOD is not considered. Further, the above-described case is restricted more than that of using the VOD in the range of program selections of viewers.

That is, there is a problem that in the above-described conventional methods, an active operation of viewers is required, or a range of program selections is restricted.

To accomplish the solution to the above-described objects, according to one aspect of the present invention, there is provided a viewing control apparatus and system which control channel switching of a broadcast program and reproduction of VOD contents. The viewing control apparatus and system generate a virtual channel in combination of the broadcast program and automatically-recommended VOD contents, control channel switching of the broadcast program and reproduction of the VOD contents based on a program list of the generated virtual channel, and switch an image displayed on a display unit.

According to the present invention, the viewing control apparatus and system can combine the broadcast program suitable for a viewer's preference and the VOD contents suitable for a viewer's preference from broad options, and organize one virtual channel along the time axis. Further, the viewing control apparatus and system have an advantage in which when viewing only the virtual channel, the viewer can passively view a favorite problem of himself or herself and the VOD contents.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating an internal configuration example of a viewing control apparatus and system.

FIG. 2 illustrates one example of a virtual channel generated in a first embodiment of the present invention.

FIG. 3 illustrates a generation flow of the virtual channel according to the first embodiment of the present invention.

FIG. 4 illustrates one example of a viewing reservation database 400.

FIG. 5 illustrates one example of a viewing desire database 500.

FIG. 6 illustrates one example of a preference database 600.

FIG. 7 illustrates one example of a setting database 700.

FIG. 8 illustrates an example in which a program list of the virtual channel is displayed on a display unit 2.

FIG. 9 is a block diagram illustrating another internal configuration example of a viewing control apparatus and system.

FIG. 10 illustrates a screen display example of a remote control terminal.

FIG. 11 illustrates one example of the virtual channel generated in a fourth embodiment of the present invention.

FIG. 12 illustrates a generation flow of the virtual channel according to the fourth embodiment of the present invention.

FIG. 13 illustrates one example of the virtual channel generated in a fifth embodiment of the present invention.

FIG. 14 illustrates a generation flow of the virtual channel according to the fifth embodiment of the present invention.

FIG. 15 illustrates one example of the virtual channel generated in a sixth embodiment of the present invention.

FIG. 16 illustrates a generation flow of the virtual channel according to the sixth embodiment of the present invention.

FIG. 17 illustrates a screen example of the display unit 2 during reproduction of a VOD.

FIG. 18 illustrates a generation flow of the virtual channel according to an eighth embodiment of the present invention.

FIG. 19 illustrates one example of the virtual channel generated in a ninth embodiment of the present invention.

FIG. 20 illustrates one example of a content database.

FIG. 21 is the entire configuration schematic diagram of the viewing control apparatus and system.

### DESCRIPTION OF THE EMBODIMENTS

### First Embodiment

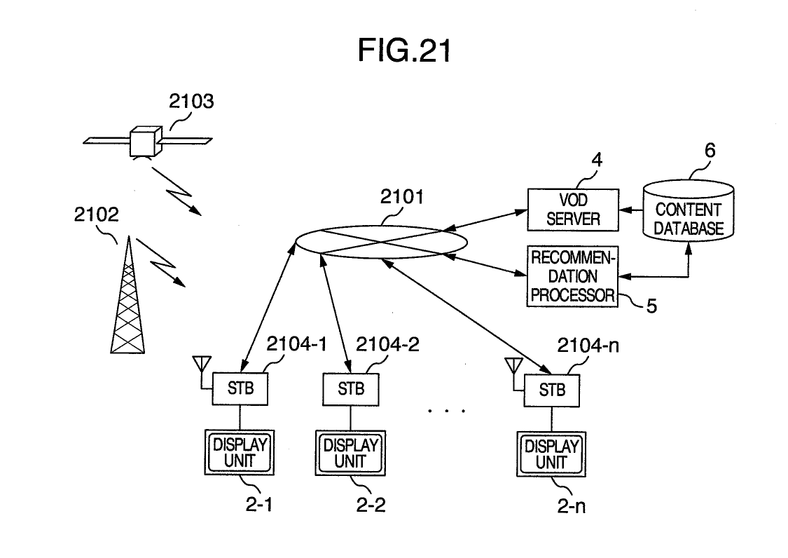

FIG. 21 is the entire configuration schematic diagram of a viewing control apparatus and system according to the present embodiment. This system includes a VOD server 4, a recommendation processor 5, a content database 6, a plurality of STBs (Set Top Box) 2104 as the viewing control apparatuses, and a plurality of display units 2, and the above-described units are connected to each other via a network 2101.

Each STB 2104 is installed, for example, at each home of a user or each room of a hotel, and connected to the display unit 2. As the display unit 2, a TV set, a personal computer, and a mobile terminal are considered. The STB 2104 receives a broadcast signal from a ground broadcast station 2102 or satellite television broadcast station 213 and causes the display unit a to display image information. Further, the STB 2104 receives image information of VOD contents from the VOD server 4 via the network 2101, and causes the display unit 2 to display the image information. An example of the viewing control apparatus according to the present embodiment includes the SIB; however, it is not limited thereto, and other apparatuses may be used.

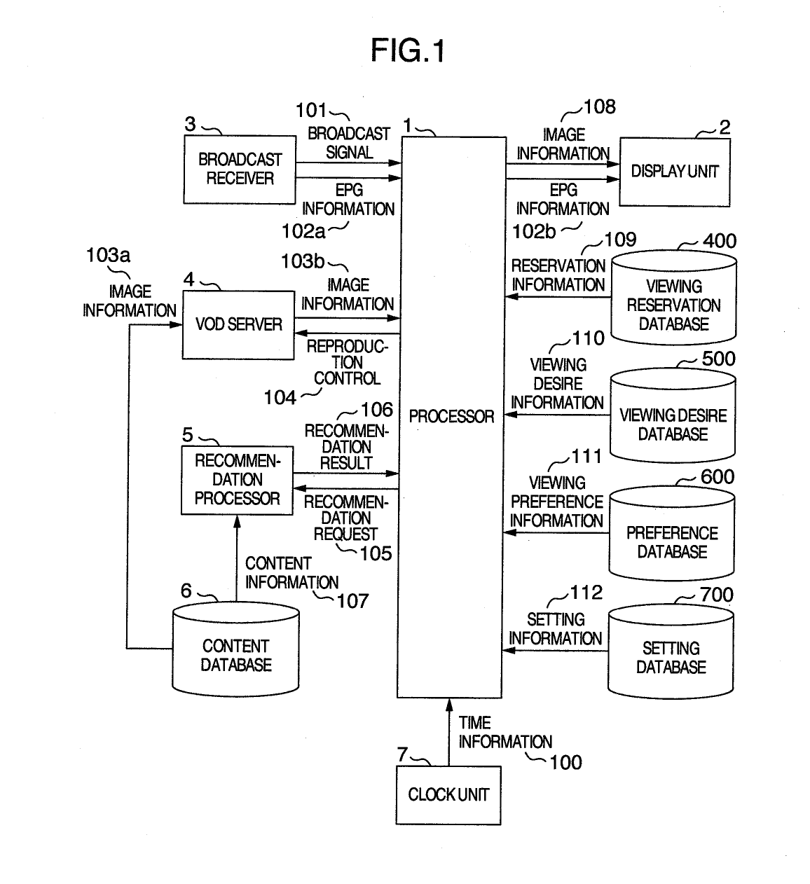

FIG. 1 is a block diagram illustrating an internal configuration of the viewing control apparatus and system according to the present embodiment. This system includes a processor 1, the display unit 2, a broadcast receiver 3, the VOD server 4, the recommendation processor 5, the content database 6, a clock unit 7, a viewing reservation database 400, a viewing desire database 500, a preference database 600, and a setting database 700. In the present embodiment, the following description will be made supposing that the processor 1, the broadcast receiver 3, the clock unit 7, the viewing reservation database 400, the viewing desire database 500, the preference database 600, and the setting database 700 are mounted within the STB 2104. The STB 2104 causes the broadcast receiver 3 to receive a broadcast signal from the ground broadcast station 2102 and the satellite television broadcast station 2103. The STB 2104 can cause the broadcast receiver 3 to receive a broadcast signal via a CATV or an IPTV. The display unit 2 is connected to the STB 2104, and displays image information and EPG (Electronic Program Guide) information. The preference database 600 can be disposed near the recommendation processor 5, and connected to the STB 2104 via the network 2101. Further, the recommendation processor 5 can be mounted within the STB 2104.

The processor 1 is composed of a computer and software. The processor 1 combines a broadcast signal 101 received by the broadcast receiver 3 and image information 103b produced from the VOD server according to a preference of a viewer, constitutes a program list as if a virtual broadcast channel is present on one time axis, and performs switching and reproduction instruction of signals. In addition, a channel is simply described also as “ch”, and a virtual broadcast channel is described also as “virtual ch”.

The display unit 2 displays the image information 108 selected by the processor 1, the EPG information 102b, and a confirmation of user registration content.

The broadcast receiver 3 receives a currently on-air broadcast program and an EPG, and supplies the broadcast signal 101 and the EPG information 102a to the processor 1. Note that broadcast signals may be supplied by any of ground-based broadcasting, satellite television broadcasting, CATV, and IPTV. Here, the EPG information 102a is expediently supplied by the broadcast receiver 3; further, the same information can be supplied by another means such as an Internet connection.

The VOD server 4 reproduces arbitrary image contents within the content database 6 by reproduction control 104 from the processor 1. The reproduced image contents are supplied to the processor 1 as the image information 103b, and displayed on the display unit 2 by a process of the processor 1.

The recommendation processor 5 extracts contents to be recommended from content information 107 within the content database 6 based on a recommendation request 105 from the processor 1. At this times for a recommendation processing, the recommendation processor 5 uses the EPG information 102a and the viewer preference information 111 supplied from the preference database 600 of viewers. The recommendation processor 5 is composed of a computer and software and, for example, an algorithm disclosed in JP-A-2009-206957 can be applied to its recommendation algorithm.

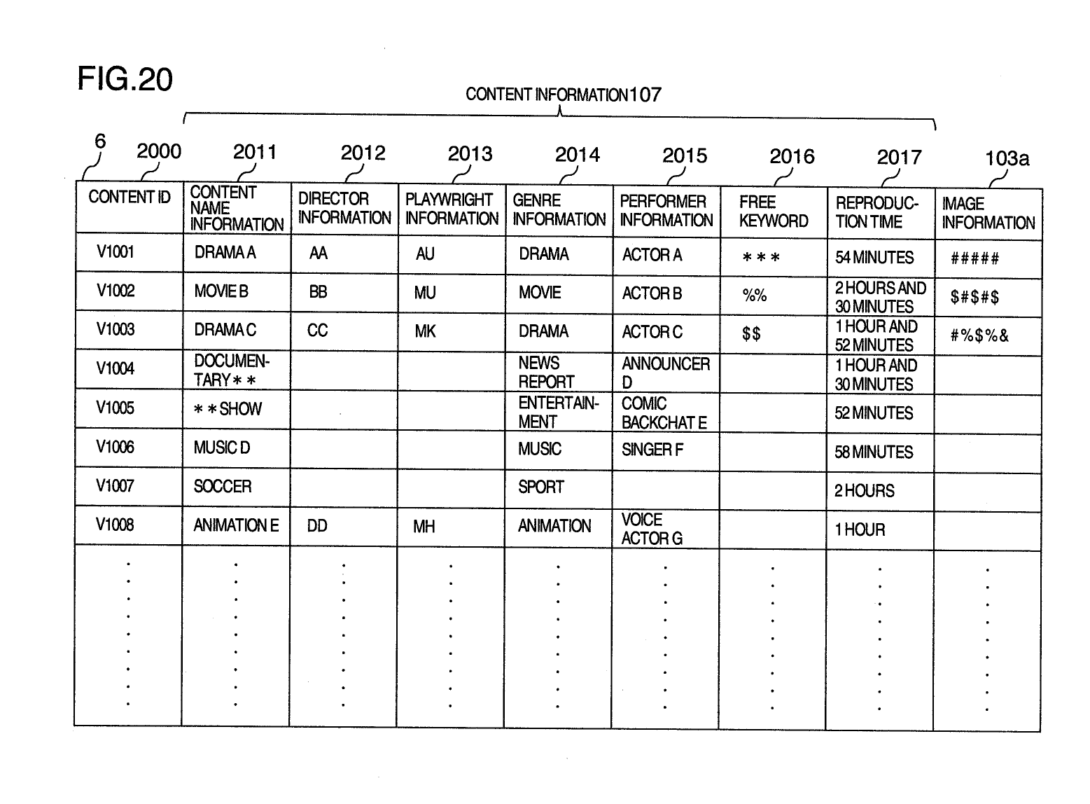

FIG. 20 illustrates one example of the content database 6. In the content database 6, the image information 103a and the content information 107 are correlated with each other by a content ID 2000 and are stored. The image information 103a is same as image information 103b transmitted to the processor 1 from the VOD server 4. In the content information 107, as data showing the feature of its content, content name information 2011, director information 2012, playwright information 2013, genre information 2014, performer information 2015, a free keyword 2016, and a reproduction time 2017 are recorded. The content information 107 is used at the time when the recommendation processor 5 performs recommendation, and as a result, the recommended content is specified by the content ID 2000. The VOD server 4 refers to the recommended content by the content ID 2000, and takes out image information 103a to thereby transmit the image information 103b to the STB 2104.

The clock unit 7 generates a time, and supplies time information 100 to the processor 1. Note that the time information 100 is the present time information including a date and time.

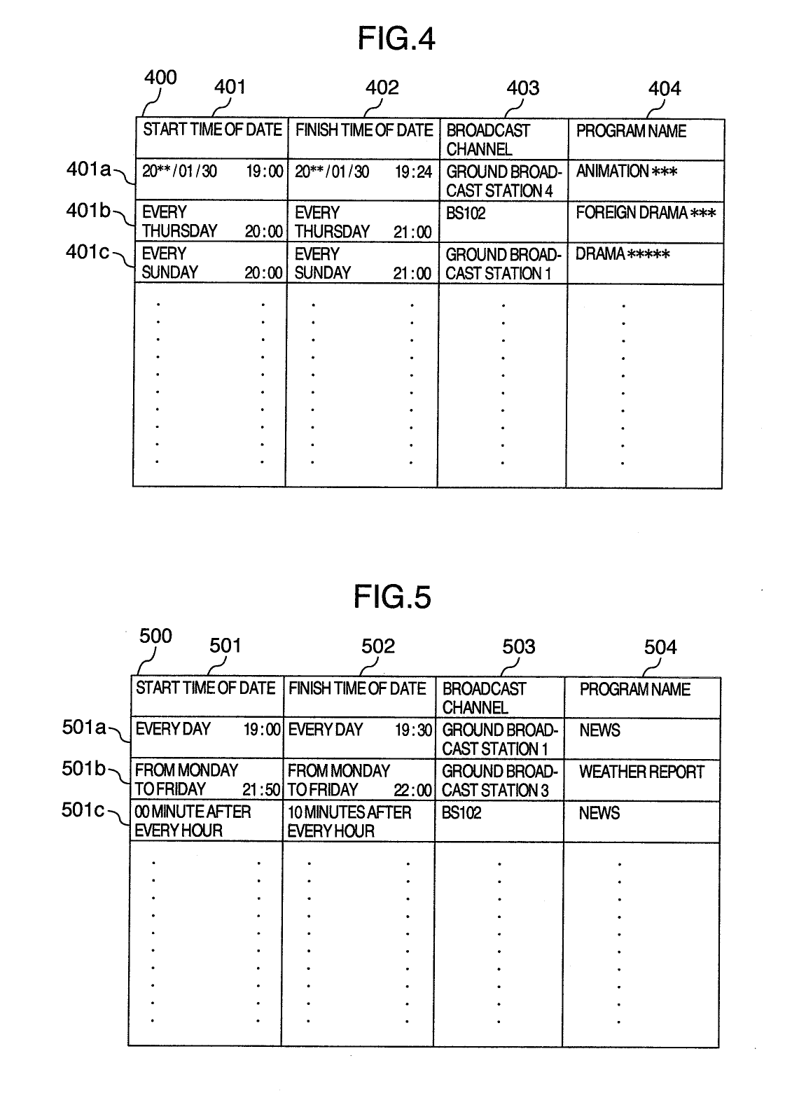

FIG. 4 illustrates one example of the viewing reservation database 400. The viewing reservation database 400 is composed of a combination of a start time of date 401a finish time of date 402, a broadcast channel 403, and a program name 404, and stores viewing reservation information on a broadcast program of viewers. Viewers select, for the viewing reservation, a program desired to be viewed from among programs broadcasted by the ground broadcast station 2102 and the satellite television broadcast station 2103 based on the EPG information. For example, viewers can reserve a particular program such as a drama viewed every week, or a news report program viewed every day. In the above-described reservation, viewers can reserve not a program basis but a part of the program. Each reservation is set in the viewing reservation database 400 based on a combination of the start time of date 401, the finish time of date 402, the broadcast channel 403, and the program name 404. The processor obtains information stored in the viewing reservation database 400 as reservation information 109, if desired.

FIG. 5 illustrates one example of the viewing desire database 500. The viewing desire database 500 is composed of a combination of a start time of date 501, a finish time of date 502, a broadcast channel 503, and a program name 504, and stores information on the desire of the program viewing of viewers. Viewers register the desire on the broadcast viewing that a news program is desired to be necessarily viewed every hour. Each viewing desire is registered based on a combination of the start time of date 501, the finish time of date 502, the broadcast channel 503, and the program name 504. A difference from the viewing reservation is that a priority order of the viewing desire is degraded than that of the viewing reservation. Specifically, when a time zone of the viewing reservation program and that of the viewing desired program are overlapped with each other, the viewing reservation program is broadcasted ahead of the viewing desired program. As a result, the viewing desired program fails to be taken into the after-mentioned virtual channel 230. The processor 1 obtains information stored in the viewing desire database 500 as the viewing desire information 110, if desired.

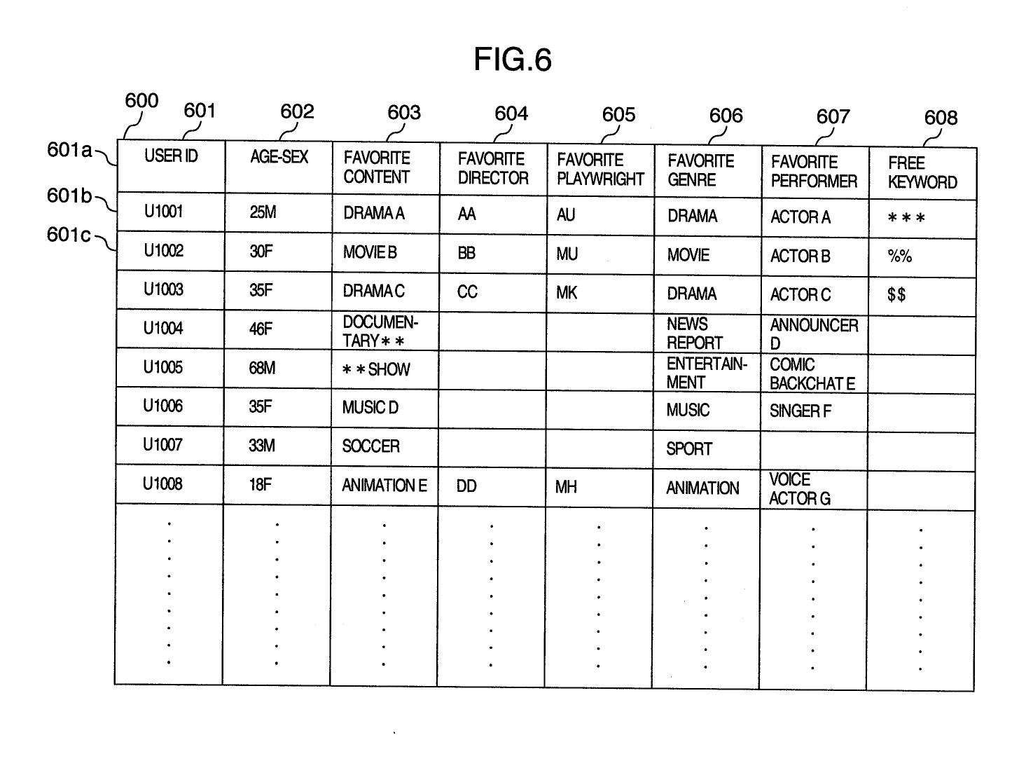

FIG. 6 illustrates one example of the preference database 600. The preference database 600 is composed, in each user ID 601, of a combination of age-sex 602, favorite content 603, a favorite director 604, a favorite playwright 605, a favorite genre 606, a favorite performer 607, and stores a favorite free keyword 608, and information on the preference of the viewing program of viewers. This database is used for the purpose of performing recommendation suitable for the viewer's preference regarding the broadcast programs and the VOD contents. The processor 1 obtains information stored in the preference database 600 as the viewing preference information 111 if desired.

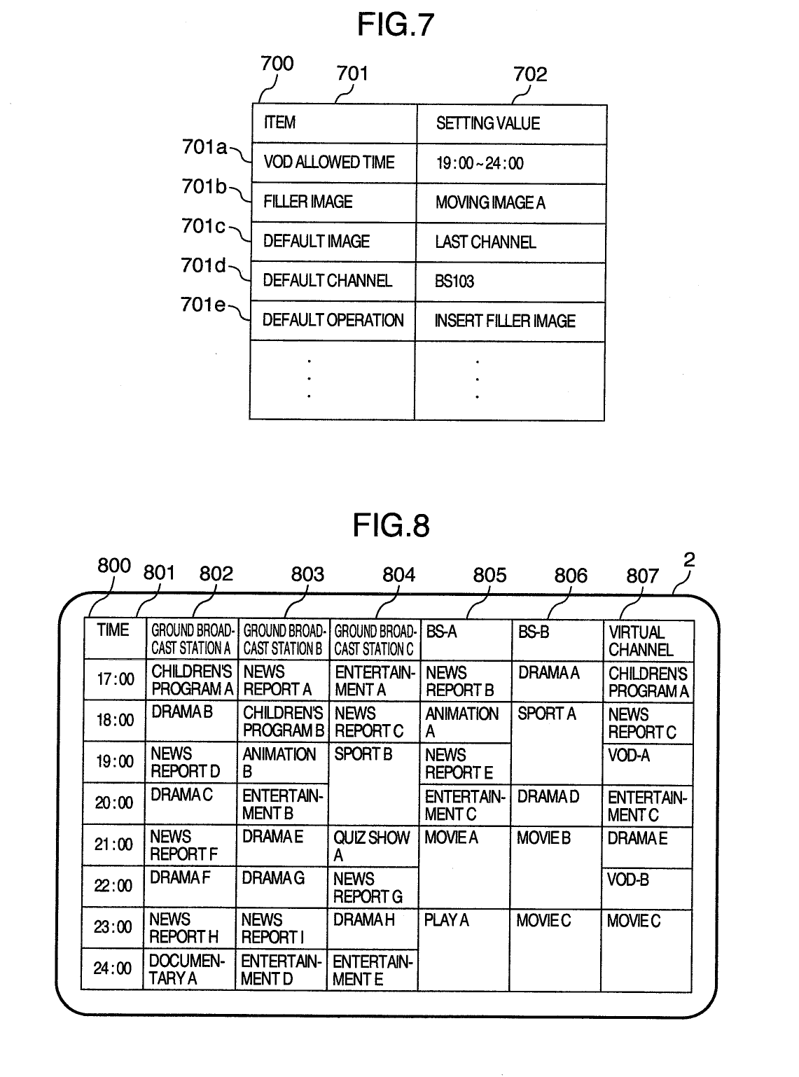

FIG. 7 illustrates one example of the setting database 700. The setting database 700 is composed of a combination of an item 701 and a setting value 702. This database stores various system setting values and setting information units of viewers not stored in the broadcast viewing reservation database 400, the broadcast viewing desire database 500, and the viewer preference database 600. The processor 1 obtains information stored in the setting database 700 as the setting information 112, if desired.

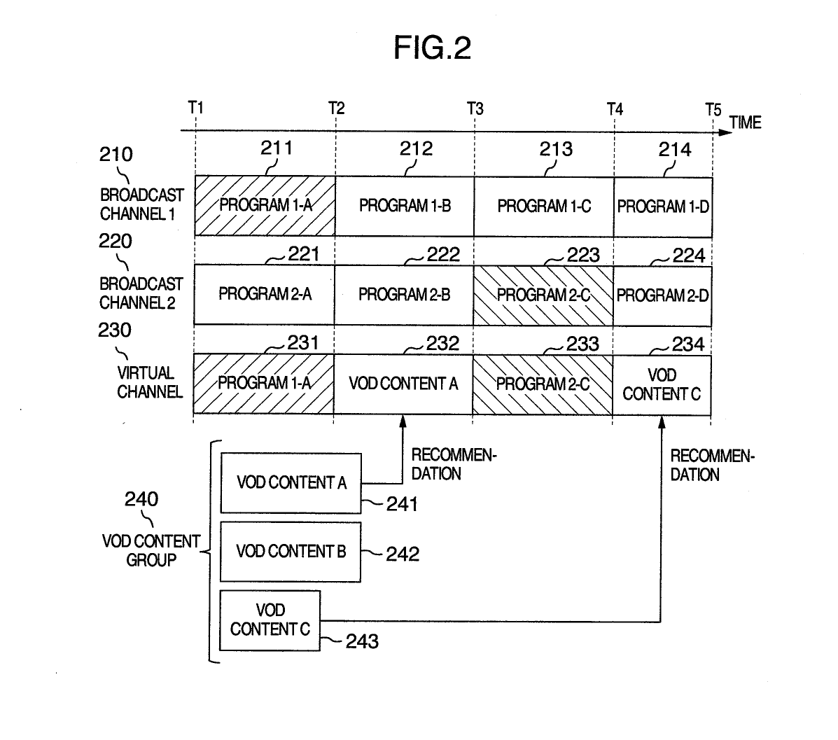

FIG. 2 illustrates one example of a virtual channel generated by the processor 1. Broadcast channels 1 210 and 2 220 each illustrate a channel broadcasted by the ground broadcast station 2102 and the satellite television broadcast station 2103, and as its content, each illustrate a program 1-A 211, program 1-B 212, program 1-C 213, program 1-D 214, program 2-A 221, program 2-B 222, program 2-C 223, and program 2-D 224. In FIG. 2, the above-described programs are aligned from left to right along the broadcast time. A VOD content group 240 corresponds to the VOD content stored in the content database 6 of FIG. 1, and is here designated as VOD contents A 241, VOD contents B 242, and VOD contents C 243, respectively.

The programs 1-A 211 and 2-C 223 are reserved for viewing by viewers. These programs are incorporated into a broadcast time of the program of the virtual channel 230 as programs 231 and 233 of the virtual channel. At this time, contents 241 and 243 recommended from the VOD content group 240 by the recommendation processor 5 are inserted into unoccupied hours 232 and 234 at which a broadcast viewing reservation is not performed, thereby performing program scheduling on the time axis of the virtual channel 230.

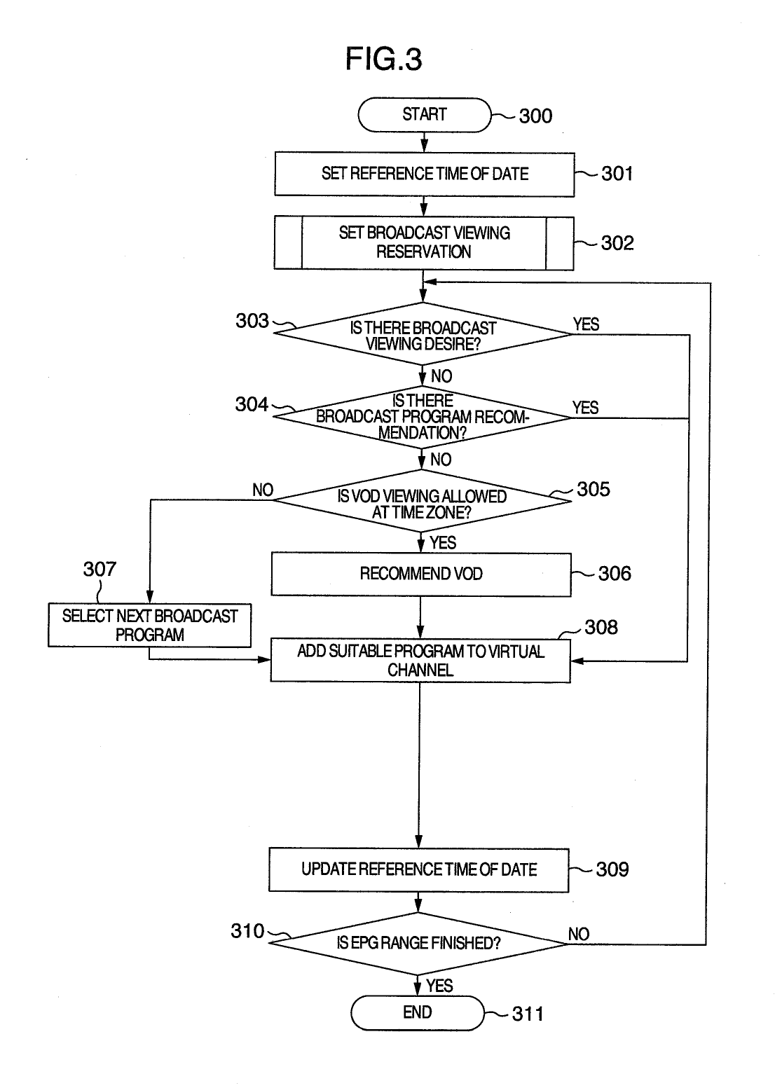

FIG. 3 illustrates a generation flow of the virtual channel according to the present embodiment. In step 301, the processor 1 sets a reference time of date at the time of starting the flow. The reference time of date means time of date information managed within this flow as a time of date obtained by adding a broadcast program or VOD contents to the virtual channel, and a start time of date of the virtual channel is first set as the reference time of date. As the start time of date, the processor 1 may obtain the time information 100 from the clock unit 7 to use the present time of date, or set an arbitrary time of date based on the desire of viewers. In an example of FIG. 2, the start time of date T1 is set as the reference time of date, and in step 301, no program is added to the virtual channel 230.

In step 302, the processor 1 determines the presence or absence of the broadcast viewing reservation based on the reservation information 109 of the viewing reservation database 400. If the broadcast viewing reservation is performed, the processor 1 adds the entire content of the broadcast viewing reservation to the virtual channel 230, and proceeds to step 303. If the broadcast viewing reservation is not performed, the processor 1 does not set anything to the virtual channel 230, and proceeds to step 303.

In an example of FIG. 2, the programs 1-A 211 and 2-C 223 are reserved for viewing by viewers, and registered in the viewing reservation database 400. Further, these programs are added to the broadcast time of the program of the virtual channel 230 as the programs 231 and 233 of the virtual channel. The start time of date T1 and finish time of date T2 of the program 1-A, or the start time of date T3 and finish time of date T4 of the program 2-C in FIG. 2 are contents of the start time of date 401 and finish time of date 402 of the program registered in the viewing reservation database 400, respectively.

In addition, in step 302, the processor 1 adds the viewing reservation program to the virtual channel 230, and updates the reference time of date. In an example of FIG. 2, since the programs 231 and 233 are added to the virtual channel 230, the reference time of date is updated to T2. FIG. 2 illustrates an example in which the program 1-A broadcasted from the start time of date T1 as the viewing reservation program is reserved, and therefore, the reference time of date is updated to T2 in step 302. However, suppose that when only the program 2-C is reserved for viewing, the reference time of date remains to be the start time of date T1.

In step 303, based on the viewing desire information 110 of the viewing desire database 500, the processor 1 searches the EPG information 102a for a program with content adapted to the viewing desire information 110 at the reference time of date. If there is the broadcast viewing desire, the processor 1 adds the program adapted to the viewing desire information 110 to the virtual channel 230 in step 308, and updates the reference time of date to the finish time of date of the added program in step 309. If there is no broadcast viewing desire, the processor 1 proceeds to step 304. In step 303, there is considered a time space between both the programs of the virtual channel 230 set in step 302. The processor 1 can set the virtual channel 230 so as to add the program which is broadcasted at that time and started and finished at the time space.

FIG. 2 illustrates an example in which the processor 1 searches the EPG information 102a for the program which is broadcasted at the reference time of date T2 and whose content is adapted to the viewing desire information 110, and since the program with content adapted to the viewing desire information 110 is not present, a program is not added to the virtual channel 230. As described above, in step 303, the processor 1 may set the virtual channel 230 so as to add the program which is broadcasted at the reference time of date T2 and finished by the start time of date T3 of the next reservation program 2-C. Or, the processor 1 may simply broadcast the added program until the time of date T3 without considering the finish time of the added program. Further, the processor 1 may add the program which is not necessarily broadcasted at the reference time of date T2 but broadcasted between the reference times of dates T2 and T3.

In step 304, based on the viewing preference information 111 of the preference database 600, the processor 1 searches the EPG information 102a for the program with the content adapted to the viewing preference information 111 at the reference time of date. If there is a broadcast program recommendation, the processor 1 adds the program with the content adapted to the viewing preference information 111 to the virtual channel 230 in step 308. Then, the processor 1 updates the reference time of date to the finish time of date of the added program in step 309. If there is no broadcast program recommendation, the processor 1 proceeds to step 305. As can be seen from the above sequence, in step 304, the processor 1 determines the presence or absence of the broadcast program to be recommended for viewing. If the broadcast program to be recommended for viewing is present, the processor 1 can add the program to the virtual channel 230. In step 304, the time space between both the programs set to the virtual channel 230 is considered in steps 302 and 303, and the processor 1 can set the virtual channel 230 so as to add the program which is broadcasted at that time, and started and finished at the time space.

FIG. 2 illustrates an example in which the processor 1 searches the EPG information 102a for the program which is broadcasted at the reference time of date T2 and whose content is adapted to the viewing preference information 111, but since the program with content adapted to the viewing preference information 111 is not present, a program is not added to the virtual channel 230. As described above, in step 304, the processor 1 may set the virtual channel 230 so as to add the program which is broadcasted at the reference time of date T2 and finished by the start time of date T3 of the next reservation program 2-C. Or, the processor 1 may simply broadcast the added program until the time of date T3 without considering the finish time of the added program. Further, the processor 1 may add the program which is not necessarily broadcasted at the reference time of date T2 but broadcasted between the reference times of dates T2 and T3.

In step 305, based on the setting information 112 of the setting database 700, the processor 1 determines whether the reference time of date is a time zone at which a VOD viewing is allowed by users. Concretely, for example, in the setting database 700 of FIG. 7, the processor 1 determines whether the reference time of date is found in the range of the setting value 702 of a VOD allowed time 701a.

When a time zone at which the VOD viewing is allowed is used, in step 306, the processor 1 transmits the recommendation request 105 of the VOD contents to the recommendation processor 5 along with information such as the viewing preference information and the EPG information 102a. On the other hand, based on the information such as the viewing preference information 111 and the EPG information 102a, the recommendation processor 5 which receives the recommendation request 105 extracts recommended information of the VOD contents from among the VOD content group 240 stored in the content database 6, and transmits the information to the processor 1 as the recommendation result 106.

The processor 1 obtains the recommendation result 106 from the recommendation processor 5, adds the recommended VOD contents to the virtual channel 230 in step 308, and updates the reference time of date to the finish tune of date of the added VOD contents in step 309.

As can be seen from the above sequence, a viewer does not perform any operation and the VOD contents suitable for the viewer's preference are automatically recommended and added to the virtual channel 730.

At this time, as to a length (reproduction time) of the VOD contents, the processor 1 can recommend the VOD contents with a length fitted into a space between both the programs already set to the virtual channel 230. Or, the processor 1 can recommend the viewing so as to divide the VOD contents and sandwich the broadcast program already set to the virtual channel 230 therebetween. Further, the processor 1 can recommend the VOD contents not fitted into a space between the already-set programs and add only a part of the VOD contents to the virtual channel 230.

When using the time zone at which the VOD viewing is not allowed in step 305, the processor 1 expediently selects a program with the same channel as that of a last broadcast program in step 307, adds the program to the virtual channel 230 in step 308, and updates the reference time of date to the finish time of date of the added program in step 309

FIG. 2 illustrates an example in which the VOD content A 232 is recommended between the reference times of dates T2 and T3, and the VOD content C 234 is recommended between the reference times of dates T4 and T5. When the reference time of date is T2 and the VOD content A 232 is added to the virtual channel 230 in step 308, since the program 2-C 233 is already registered from the time of date T3, the reference time of date is updated to T4 as the finish time of date of the program 2-C 233 in step 309. In the same manner, the VOD content C 234 is recommended between the times of dates T4 and T5, and added to the virtual channel 230

In step 310, the processor 1 determines whether this series of flow is performed from the start time of date up to a range finish of the obtained EPG information 102a (namely, determines whether the reference time of date gets up to a range finish of the EPG information 102a). When the series of flow is performed up to a range finish of the EPG information 102a, the processor 1 ends the generation of the virtual channel. Note that this process range is not limited to a range finish of the EPG information 102a and further, the processor 1 can arbitrarily specify a period of time such as one day.

In the present embodiment, a priority to be set to the virtual channel 230 is set in the order corresponding to the broadcast viewing desire (step 303), the broadcast program recommendation (step 304), and the VOD recommendation (step 306); however, the priority can be changed. The change in the priority can be performed by changing a performance order from step 303 to step 306.

In addition, when a program in unoccupied hours is decided, a profit of viewers is considered in the case where the VOD content is charged. Based on the preference previously registered by viewers, a broadcast program suitable for the viewer's preference can be first selected from free on-air programs or monthly charge on-air programs, and taken into the virtual channel. Note that in this case, any program need not necessarily be selected in the on-air program recommendation. When the on-air program recommendation is lower than a predetermined reference recommendation, the broadcast program is not selected for recommendation and the VOD content is selected for recommendation.

When a user views the virtual channel 230, the program and VOD contents set to the virtual channel 230 in the above-described procedures are displayed on the display unit 2 according to the time. Specifically, based on the time information of the clock unit 7, the processor 1 controls a change in channels of the broadcast receiver 3 according to contents of the virtual channel 230. Further, the processor 1 controls an access to the VOD server and automatically reproduces the required contents, thereby switching and controlling the contents displayed on the display unit 2.

According to the present embodiment, one method for configuring the virtual channel 230 is illustrated. According to the present embodiment, the proposed viewing control apparatus and system have an advantage in which when viewing the virtual channel 230, a user can view a program suitable for a request and preference of himself or herself. In addition, the viewing control apparatus and system have an advantage in which since the contents suitable for the user's preference are automatically recommended and automatically reproduced from the VOD contents, the user can passively view the VOD contents having rich options and saving the trouble of a content search and reservation of the general VOD viewing.

### Second Embodiment

FIG. 8 illustrates an example in which a program list of the virtual channel 230 is displayed on the display unit 2. A program list of the virtual channel 230 is displayed on the display unit 2 in conjunction with the electronic program guide 800 of the broadcast program. According to the present embodiment, the broadcast programs are illustrated in a tabular form with the vertical axis representing the time 801 and the horizontal axis representing the broadcasting stations 802 to 806. A program list 807 of the virtual channel 230 is illustrated in conjunction with their time zones, and list visibility of users is improved.

The above-described electronic program guide 800 is obtained by causing the processor 1 to add program information such as viewing recommendation and VOD recommendation to the EPG information 102a from the broadcast receiver 3 and produce the program information as the EPG information 102b.

### Third Embodiment

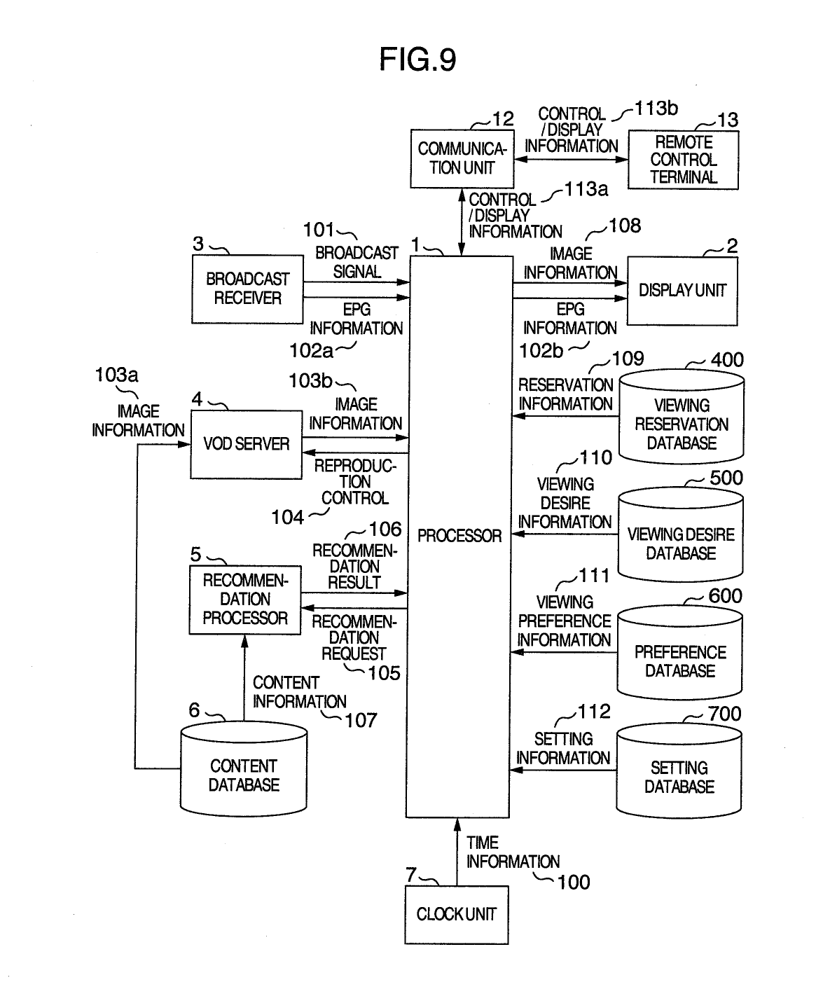

FIG. 9 is a block diagram illustrating an internal configuration of the viewing control apparatus and system according to the present embodiment. In the present embodiment, in addition to a configuration according to the first embodiment (FIG. 1), a communication unit 12 and a remote control terminal 13 are connected to the processor 1 for the purpose of displaying a program list of the virtual channel on the remote control terminal 13. Between the processor 1 and the communication unit 12, control/display information 113a is exchanged. Further, between the communication unit 12 and the remote control terminal 13, control/display information 113b is exchanged. Based on the above-described control/display information 113, instructional information through the remote control terminal 13 is transmitted to the processor 1 and a screen image displayed on the remote control terminal 13 is transmitted by the processor 1. Further, as a transmission path between this communication unit 12 and the remote control terminal 13, a short-range wireless system such as infrared radiation, wireless LAN, and Bluetooth may be used, or a broadband network such as mobile networks may be used.

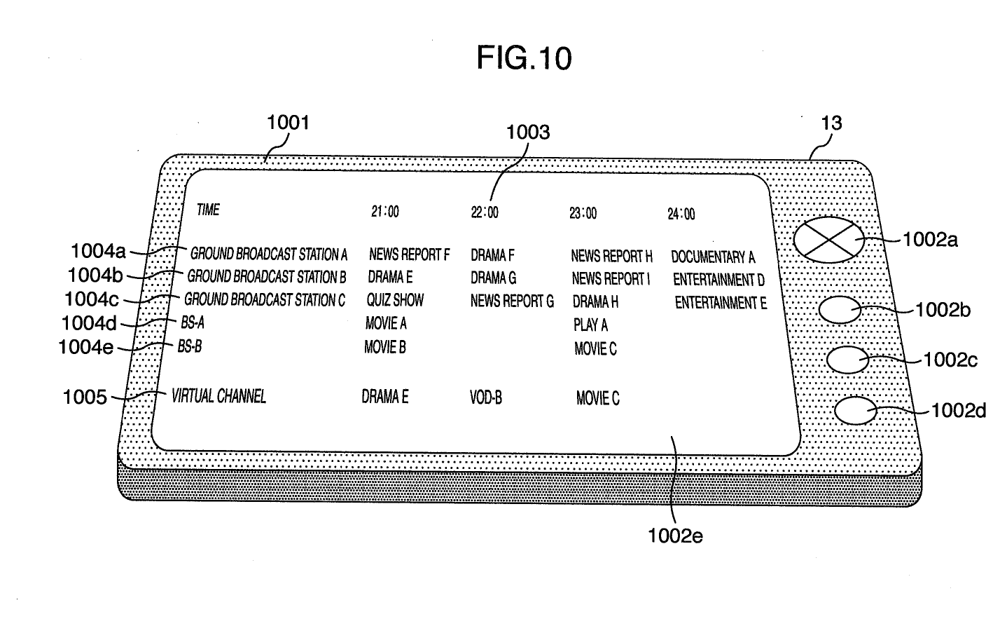

FIG. 10 illustrates a screen display example of the remote control terminal 13. The remote control terminal 13 is composed of a display unit 1001 and operation units 1002a to 1002e. A reference numeral 1002e denotes a touch panel. The display unit 1001 displays a program list having the horizontal axis representing the time 1003 and the vertical axis representing the broadcasting stations 1004a to 1004e, and at the same time, displays a program list 1005 of the virtual channel 230. According to the present embodiment, since the program list is displayed on the remote control terminal 13, the search and switching of programs can be performed without switching the display of a TV set. Further, depending on a configuration of the communication unit 12, a general-purpose device such as a mobile-phone can be used as the remote control terminal 13.

According to the present embodiment, the proposed viewing control apparatus and system have an advantage in which a user can perform confirmation or change of contents of the virtual channel by using a remote control to final under the user's hand, and as a result, user-friendliness is improved.

### Fourth Embodiment

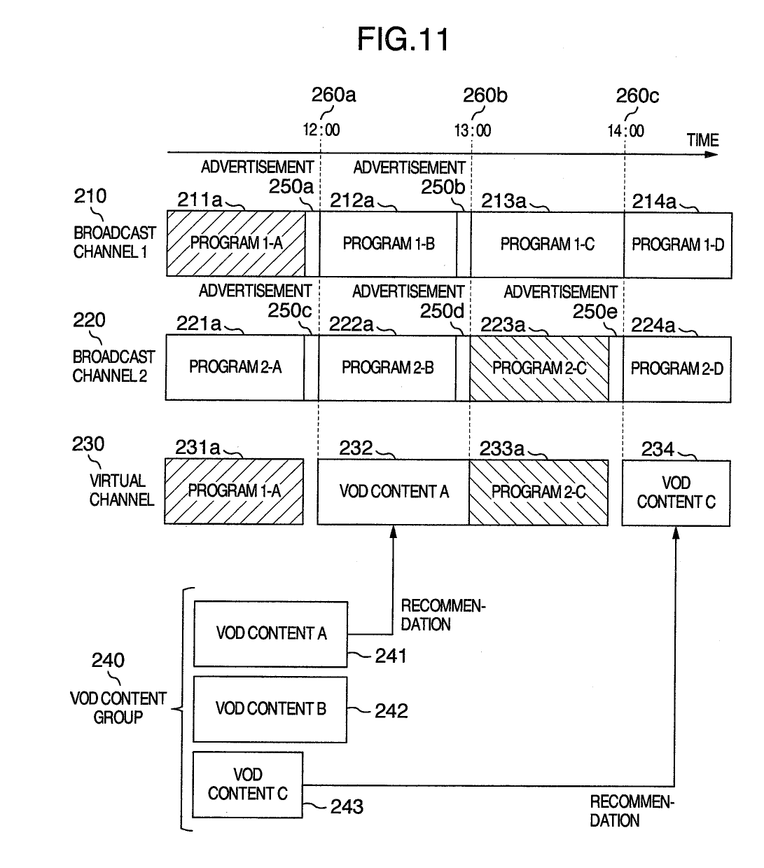

FIG. 11 illustrates one example of the virtual channel generated according to the present embodiment. The present embodiment illustrates an example in which a reproduction start time of the VOD contents of the virtual channel is adjusted to a separation time of the broadcast program on the hour every hour.

Before and after the broadcasting of the broadcast programs 211a and 223a, advertisements 250a to 250e are broadcasted or another brief program is broadcasted in many cases. When considering that the VOD content group 240 includes an original broadcast program and movie, a reproduction time of the VOD contents is considered to be approximated to a broadcast time of one broadcast program in many cases. Accordingly, for the purpose of generating the virtual channel 230 over an extended time period, the VOD content 240 is desired to be also finished at a switching timing of the broadcast program.

FIG. 11 illustrates a case in which when generating the virtual channel 230, the broadcast viewing reservation is set to the programs 1-A 211a and 2-C 223a. Before the next program 1-B 212a is started after completion of the program 1-A 211a, an advertisement 250a is broadcasted. In the same manner, before the next program 2-D 224a is started after completion of the program 2-C 223a, an advertisement 250e is broadcasted.

For this purpose, in the present embodiment, when the VOD content A232 is added to the virtual channel 230, its reproduction start time is not set to an immediate aftermath of the program 231a, and is delayed to just twelve o'clock 260a. In the same manner, the reproduction start time of the VOD content C234 added to the virtual channel 230 is not set to an immediate aftermath of the program 233a, and is delayed to just fourteen o'clock, 260c.

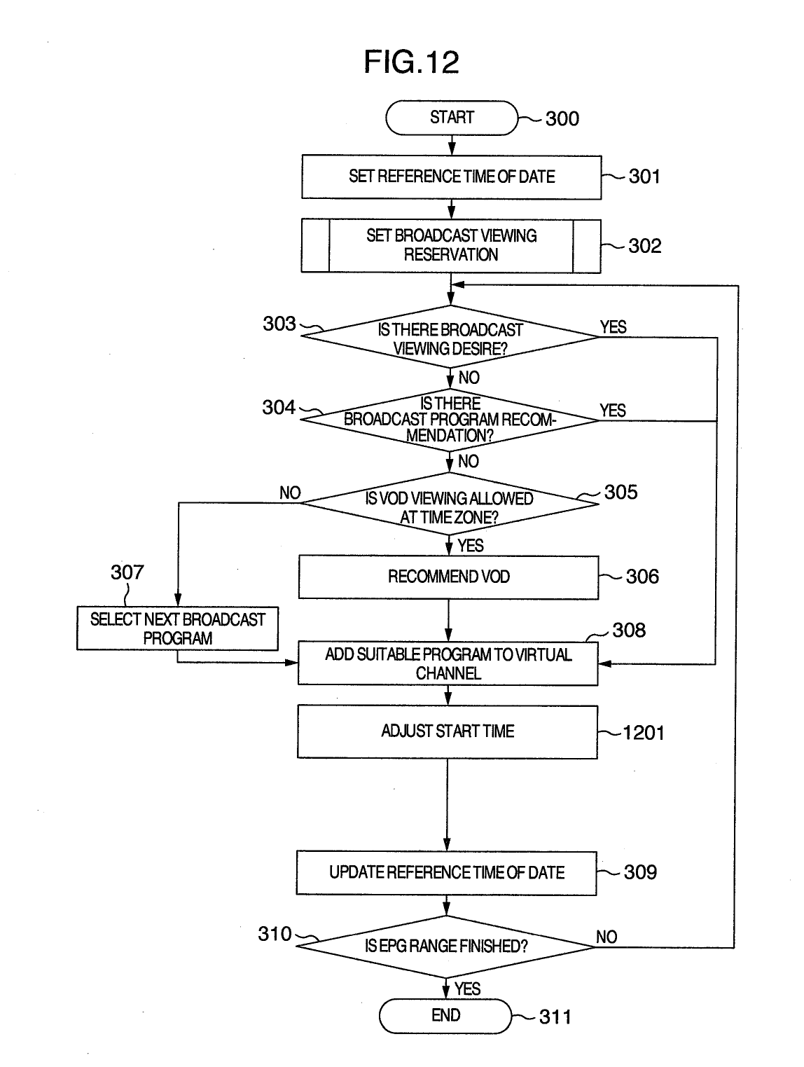

FIG. 12 illustrates the generation flow of the virtual channel according to the present embodiment. A difference from the first embodiment is that step 1201 is added to the generation flow according to the first embodiment. According to the present embodiment, after the VOD contents are added to the virtual channel 230 in step 308, a start time of the VOD contents added in step 1201 is adjusted to be tuned to a separation time such as the hour every hour. As a matter of course, even if the start time of the VOD contents is not limited to the hour every hour, but is tuned to any other time, the above-described adjustment can be performed.

According to the present embodiment, the proposed viewing control apparatus and system have an advantage in which a user can adjust a viewing start time of the VOD contents to a general broadcast program, and therefore, is easy to view the general broadcast program before and after the VOD viewing.

### Fifth Embodiment

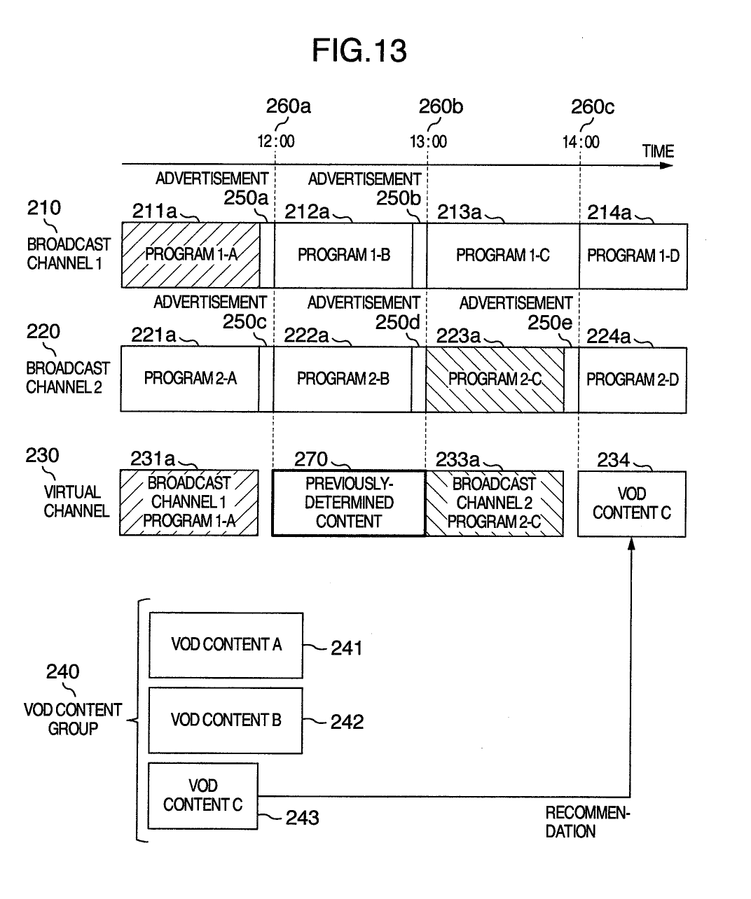

FIG. 13 illustrates one example of the virtual channel generated in the present embodiment. The programs 231a and 233a which are reserved for the broadcast viewing are registered in the virtual channel 230. However, it is supposed that the viewing reservation program, the viewing desired pro and the VOD recommendation are not inserted between both of the programs.

In the present embodiment, contents to be inserted in the above-described case are previously determined and registered in the setting database 700, thereby inserting a previously-determined content 270. This previously-determined content 270 can be set to the broadcast channel viewed immediately before (note that in the case of viewing the VOD immediately before, the broadcast channel viewed immediately before the VOD viewing). Further, a particular broadcasting station can be specified as to this previously-determined content 270.

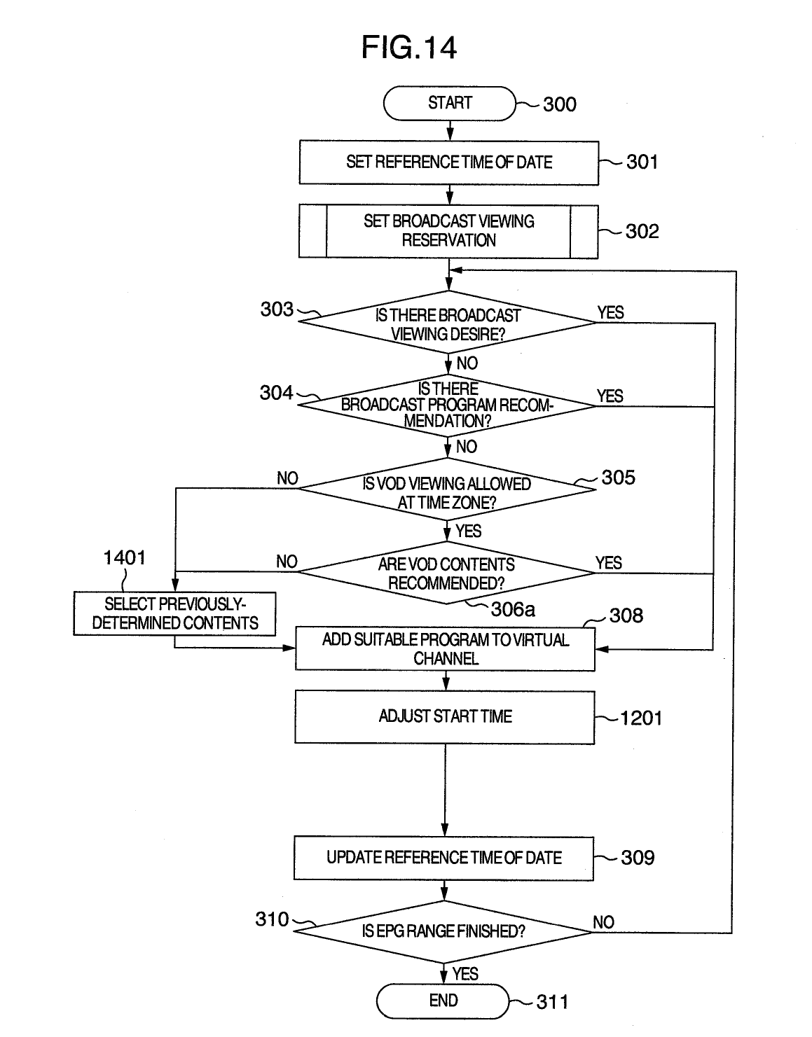

FIG. 14 illustrates a generation flow of the virtual channel according to the present embodiment. A difference from the fourth embodiment (FIG. 12) is that step 306 is changed, and step 307 is changed into step 1401. In the present embodiment, when the VOD viewing is determined to be not allowed in step 305, and when the VOD contents are not recommended in step 306a, the previously-determined content is selected in step 1401 and added to the virtual channel 230 in step 308. In step 1401 the processor 1 refers to the setting database 700 of FIG. 7 and selects the previously-determined contents based on the setting information 112 such as records 701c, 701d, and 701e.

According to the present embodiment, the proposed viewing control apparatus and system have an advantage in which even when the viewing reservation program and recommendation of the VOD contents are not inserted during the viewing of the virtual channel 230, a user can keep on viewing the previously-determined content and view the previously-determined desired content of myself even in that case.

### Sixth Embodiment

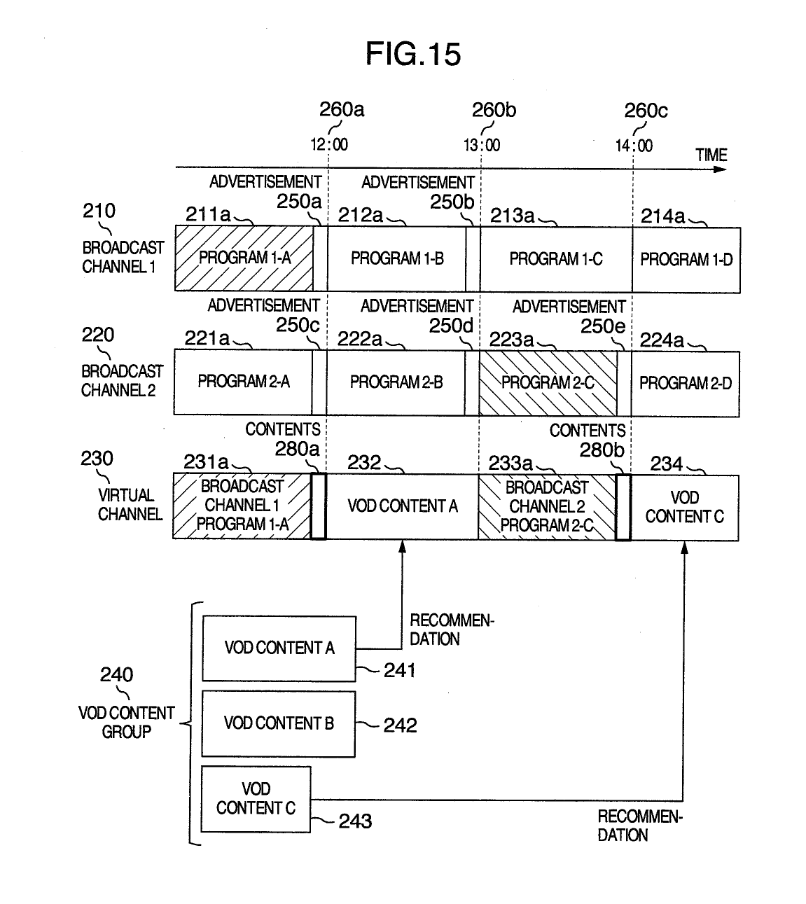

FIG. 15 illustrates one example of the virtual channel generated in the present embodiment. The present embodiment illustrates an example in which when a space within a specified time is left between both the broadcast programs incorporated into the virtual channel 230, or between the broadcast program and the VOD content, a particular content (filler) 280 is inserted therebetween.

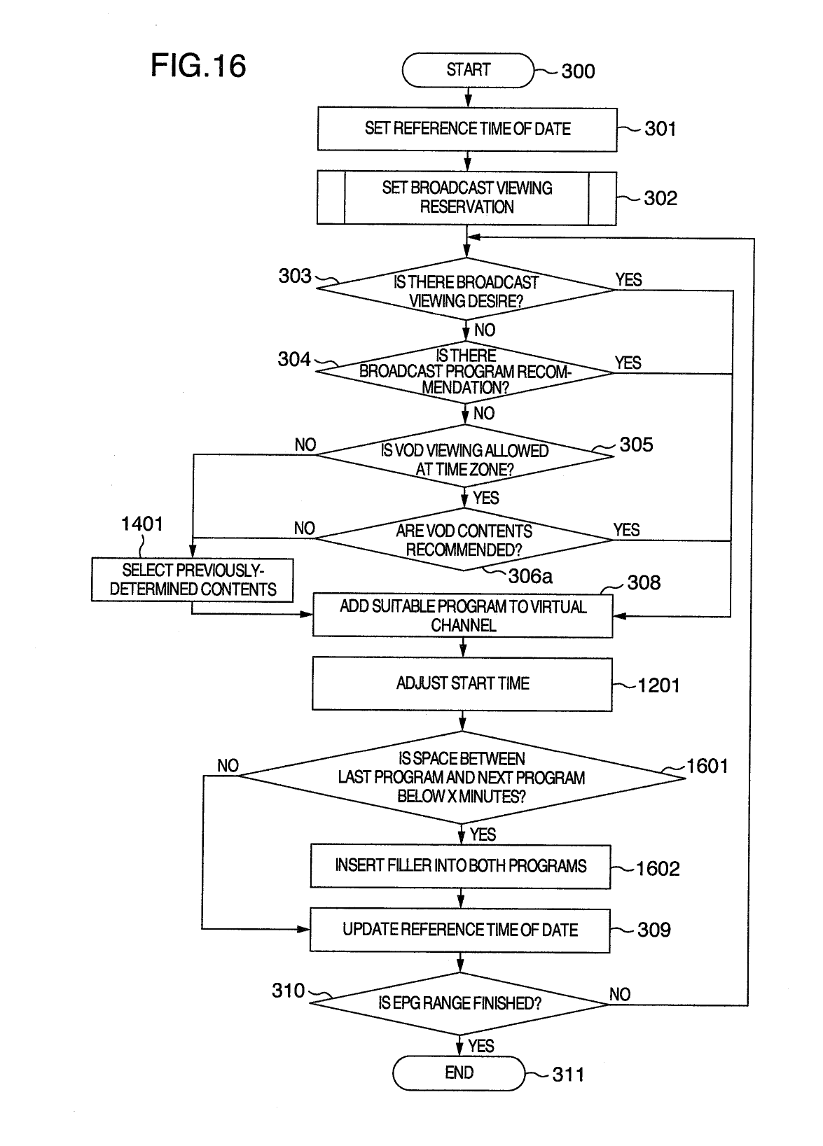

FIG. 16 illustrates a generation flow of the virtual channel according to the present embodiment. A difference from the fifth embodiment (FIG. 14) is that steps 1601 and 1602 are added to the generation flow according to the fifth embodiment. In the present embodiment, after an insertion time of the VOD contents is adjusted in step 1201, the processor 1 determines whether a space between a last program and the added VOD content is left within a specified time in step 1601. If the space is left over a predetermined specified time, the processor 1 updates the reference time of date to the finish time of date of the last program in step 309, searches for the viewing desire, and recommends the VOD again. If the space between the last program and the added VOD contents is left within a specified time in step 1601, the processor 1 inserts a particular content (filler) 280 between both the programs in step 1602.

This particular content (filler) 280 is kept like a record 701b of the previously-determined setting database 700, and the processor 1 can obtain the contents and in the same manner, reproduce the VOD contents based on the setting. As a matter of fact, the processor 1 can specify an advertisement different from the broadcast as the VOD contents.

As the particular content (filler) 280, a last-viewed broadcast channel can be specified, or a previously-determined broadcast channel can be specified.

According to the present embodiment, the proposed viewing control apparatus and system have an advantage in which when viewing the virtual channel 230, a user need not view an advertisement inserted between both the programs, or between the program and the VOD content.

### Seventh Embodiment

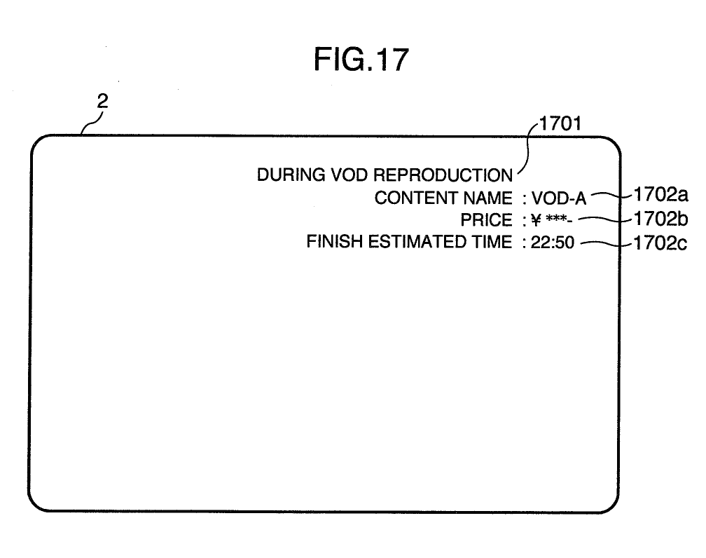

FIG. 17 illustrates a screen example of the display unit 2 during the reproduction of the VOD content. The present embodiment illustrates an example in which when the VOD contents are reproduced during the viewing of the virtual channel 230, a display 1701 to the effect that the VOD content is reproduced, a content name 1702a, a price 1702b, and a finish estimated time 1702c are displayed on a screen of the display unit 2.

According to present embodiment, the proposed viewing control apparatus and system have an advantage in which the user can easily determine whether an image during the viewing at present is displayed depending on the broadcasting or the VOD during the viewing of the virtual channel 230. Further, the viewing control apparatus and system have an advantage in which when the VOD is viewed in particular, a price can be confirmed in the case of paid content or whether a trick play operation is performed can be confirmed.

### Eighth Embodiment

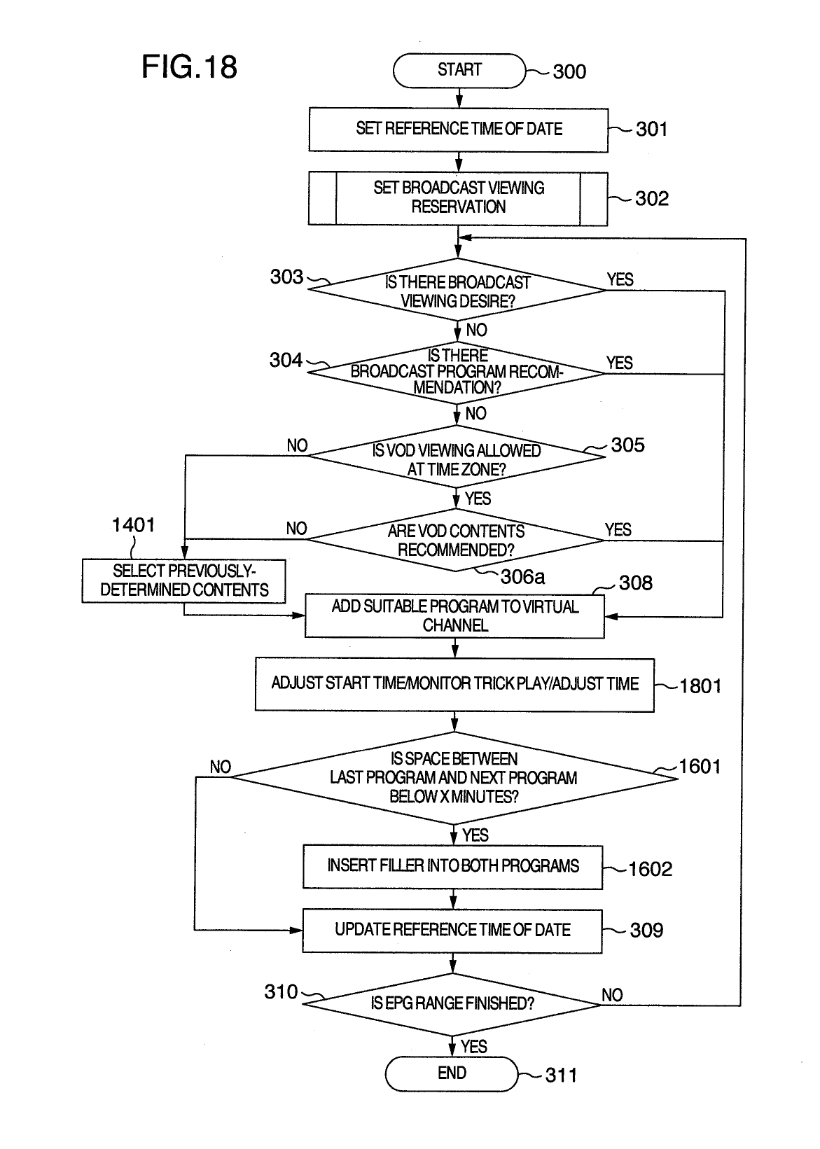

FIG. 18 illustrates a generation flow of the virtual channel according to the present embodiment. A difference from the sixth embodiment (FIG. 16) is that step 1201 is changed into step 1801. The present embodiment illustrates an example in which when a trick play operation such as pause, rewinding, and fast forward is performed at the time of reproducing the VOD contents 240 in the virtual channel 230 generated in the first embodiment to the seventh embodiment, since the finish time of the VOD contents changes, the next program and content are readjusted in conjunction with the change in the finish time.

In the present embodiment, at the time of generating the virtual channel 230, when a trick play operation is monitored at the time of generating the VOD contents 240 and the VOD reproduction finish time is recalculated in step 1801, the VOD reproduction finish time on which the trick play operation is reflected is delivered to subsequent steps and is reflected on the subsequent processings. Accordingly, the reference time of date is updated to the VOD reproduction finish time of date on which the trick play operation is reflected in step 309. The monitoring of the trick play operation can be realized, for example, when the processor 1 receives the control/display information 113 as operation information of the remote control terminal 13 and stores operation contents of the trick play operation.

According to the present embodiment, the proposed viewing control apparatus and system have an advantage in which even when the viewing finish time is significantly changed by the trick play operation, since a program suitable to a user's preference is set in the virtual channel 230, a user can continuously view a program suitable to the preference of himself or herself.

### Ninth Embodiment

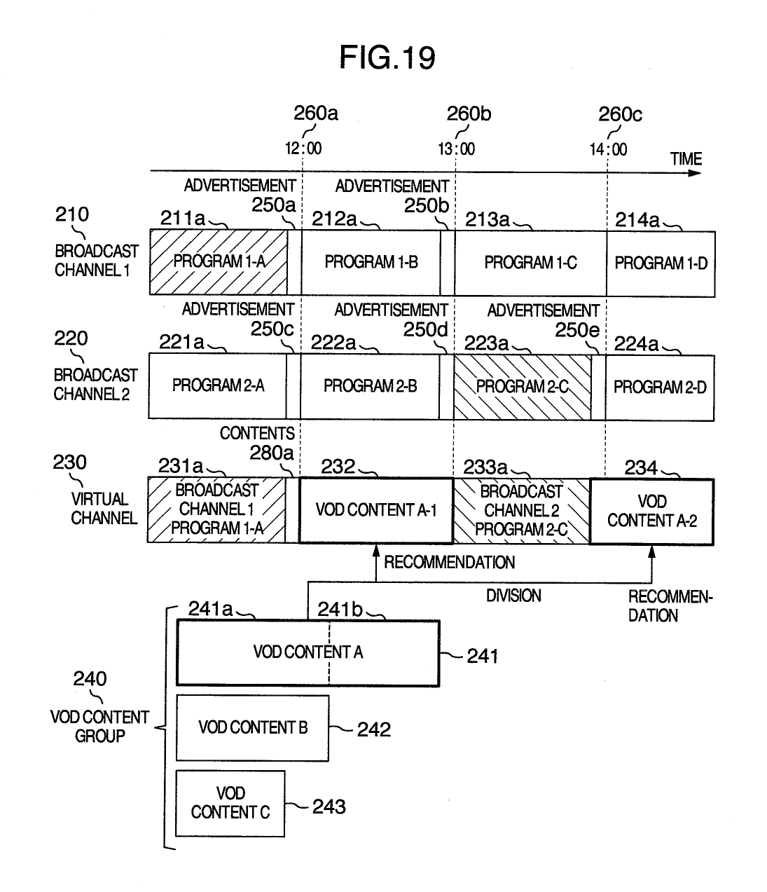

FIG. 19 illustrates one example of the virtual channel generated in the present embodiment. The present embodiment illustrates an example in which the VOD contents 240 in the virtual channel 230 is divided into anterior and posterior portions of the viewing reservation program to be reproduced.

The viewing control apparatus and system according to the present embodiment can correspond to the trick play operation in the same manner as in the eighth embodiment, and therefore, a flowchart is the same as that of the eighth embodiment. In the present embodiment, the reference time of date is updated to the finish time of the divided VOD contents A-2 in step 309.

According to the present embodiment, the proposed viewing control apparatus and system can improve a degree of freedom of user's viewing by recommending the division viewing even when a space between both the programs reserved for viewing is narrow and the VOD contents with a long viewing time, such as movie cannot be continuously viewed. Further, the viewing control apparatus and system can provide improvement in the convenience in which regular news is viewed at the time of viewing a long movie by using the VOD.

It should be further understood by those skilled in the art that although the foregoing description has been made on embodiments of the invention, the invention is not limited thereto and various changes and modifications may be made without departing from the spirit of the invention and the scope of the appended claims.

1. A viewing control apparatus comprising a processor which controls channel switching of a broadcast program and reproduction of Video On Demand (VOD) contents,
wherein:
the processor generates a virtual channel in combination of the broadcast program and automatically-recommended VOD contents, controls channel switching of the broadcast program and reproduction of the VOD contents based on a program list of the generated virtual channel, and switches an image displayed on a display unit.

2. The viewing control apparatus according to claim 1,
wherein:
when generating the virtual channel, the processor adds to the virtual channel as the broadcast program at least one of a broadcast program which is reserved for viewing, a broadcast program which is desired for viewing, a broadcast program which is recommended for viewing, a previously-determined broadcast program, and a previously-determined image.

3. The viewing control apparatus according to claim 1,
wherein:
the processor adds the broadcast program which is reserved for viewing to the virtual channel and adds at least the VOD contents to a time zone at which the broadcast program which is reserved for viewing is not broadcasted to thereby generate the virtual channel.

4. The viewing control apparatus according to claim 1,
wherein:
the processor adjusts a time such that a reproduction start time of the VOD contents is matched with a predetermined separation time to thereby generate the virtual channel.

5. The viewing control apparatus according to claim 1,
wherein:
when a reproduction finish time of the VOD contents is changed by a viewer operation performed during reproduction of the VOD contents, the processor reflects the changed reproduction finish time to thereby generate the virtual channel again.

6. The viewing control apparatus according to claim 1,
wherein:
the processor divides the VOD contents and adds the divided VOD contents to the virtual channel so as to sandwich the broadcast program therebetween.

7. A viewing control system comprising:
a viewing control apparatus which controls channel switching of a broadcast program and reproduction of VOD contents; and
a display unit which displays an image,
wherein:
the viewing control apparatus generates a virtual channel in combination of the broadcast program and an automatically-recommended VOD content, and controls channel switching of the broadcast program and reproduction of the VOD contents based on a program list of the generated virtual channel; and
the display unit switches and displays the broadcast program and the VOD contents by the control of the viewing control apparatus.

8. The viewing control system according to claim 7,
wherein:
the display unit displays a program list of the virtual channel generated by the viewing control apparatus in conjunction with a program list of the broadcast program.

9. The viewing control system according to claim 7, further comprising a remote control terminal,
wherein:
the remote control terminal displays a program list of the virtual channel generated by the viewing control apparatus in conjunction with a program list of the broadcast program.

10. The viewing control system according to claim 7,
wherein:
the display unit displays, when displaying the VOD contents, at least one information unit of reproduction of the VOD contents, a price of the VOD contents, and a reproduction time of the VOD contents.

11. The viewing control system according to claim 7,
wherein:
the viewing control apparatus adds, when generating the virtual channel, to the virtual channel as the broadcast program at least one of a broadcast program which is reserved for viewing, a broadcast program which is desired for viewing, a broadcast program which is recommended for viewing, a previously-determined broadcast program, and a previously-determined image.

12. The viewing control system according to claim 7,
wherein:
the viewing control apparatus adds a broadcast program which is reserved for viewing to the virtual channel and adds at least the VOD contents to a time zone at which the broadcast program which is reserved for viewing is not broadcasted to thereby generate the virtual channel.

13. The viewing control system according to claim 7,
wherein:
the viewing control apparatus adjusts a time such that a reproduction start time of the VOD contents is matched with a previously-determined separation time to thereby generate the virtual channel.

14. The viewing control system according to claim 7,
wherein:
when a reproduction finish time of the VOD contents is changed by a viewer operation performed during reproduction of the VOD contents, the viewing control apparatus reflects the changed reproduction finish time to thereby generate the virtual channel again.

15. The viewing control system according to claim 7,
wherein:
the viewing control apparatus divides the VOD contents and adds the divided VOD contents to the virtual channel so as to sandwich the broadcast program therebetween.
